(19) United States
(12) Patent Application Publication
(10) Pub. No.: US 2020/0350991 A1
(43) Pub. Date: Nov. 5, 2020

(54) OPTICAL SYSTEM HAVING A BIDIRECTIONAL INTERLEAVED OPTICAL LINK

(71) Applicant: Hewlett Packard Enterprise Development LP, Houston, TX (US)

(72) Inventors: Thomas Van Vaerenbergh, Palo Alto, CA (US); Raymond G. Beausoleil, Seattle, WA (US); Kevin B. Leigh, Houston, TX (US); Di Liang, Santa Barbara, CA (US); Terrel Morris, Garland, TX (US); Paolo Faraboschi, Sant Cugat (ES)

(21) Appl. No.: 16/399,176

(22) Filed: Apr. 30, 2019

(51) Int. Cl. H04B 10/25; H04J 14/02; G02B 6/42; G02F 1/01; H04B 10/50; H04B 10/66

(52) U.S. Cl. CPC H04B 10/2503; H04J 14/02; G02B 6/4246; H04B 10/66; H04B 10/504; H04B 10/2504; G02F 1/011

(57) ABSTRACT

Examples herein relate to optical systems. In particular, implementations herein relate to an optical system including a bidirectional optical link such as an optical fiber. The optical system includes first and second optical modules coupled to opposing ends of the optical fiber. The first optical module is configured to transmit optical signals across the optical fiber in a first direction and the second optical module is configured to transmit optical signals across the optical fiber in a second direction opposite the first direction. Each of the first and second optical modules includes a multi-wavelength optical source configured to emit light. Respective channel spacing of the multi-wavelength optical sources of the first and second optical modules are offset from each other such that the respective wavelengths of the emitted light transmitted across the optical fiber from the first and second optical sources do not overlap.

### BACKGROUND

Optoelectronic communication (e.g., using optical signals to transmit electronic data) is becoming more prevalent as a potential solution, at least in part, to the ever increasing demand for high bandwidth, high quality, and low power consumption data transfer in applications such as high performance computing systems, large capacity data storage servers, and network devices. Wavelength division multiplexing (WDM) is useful for increasing communication bandwidth by combining and sending multiple different data channels or wavelengths from one or more optical sources over an optical fiber. Generally, optical systems or interconnects include an optical link having fiber pairs (e.g., one fiber for transmitting wavelengths and a separate fiber for receiving wavelengths). An improved optical system having a bidirectional link with a single optical fiber for both transmitting and receiving multiple wavelengths as described herein may reduce fiber count by half and in turn may reduce part costs as well as manufacturing or assembly costs.

### BRIEF DESCRIPTION OF THE DRAWINGS

Certain examples are described in the following detailed description and in reference to the drawings, in which:

FIGS. 1A and 1B schematically illustrate block diagrams of examples of optical systems according to the present disclosure; and

FIGS. 2A-2D schematically illustrate qualitative and quantitative charts of example channel line spacing of optical sources of the optical systems according to the present disclosure; and

FIGS. 3A-3C schematically illustrate block diagrams of other examples of optical systems according to the present disclosure.

### DETAILED DESCRIPTION OF SPECIFIC EXAMPLES

The present disclosure describes various examples of a WDM optical system (e.g., an optical interconnect) that includes a bidirectional interleaved optical link (e.g., an optical fiber connection) between optical modules (e.g., transceivers). In particular, silicon photonics interconnects are provided herein that can support bandwidth or wavelengths for dense wavelength division multiplexing (DWDM) between such optical modules. For example, a multiplexer can be used to join the optical signals emitted by a respective optical module together before transmitting them over the optical fiber, and a demultiplexer can subsequently be used to separate the optical signals transmitted by the optical fiber to be received by a plurality of photodetectors, as described in more detail below.

The optical modules as described herein are coupled to opposing ends of a single optical fiber allowing multiple wavelengths or groups of wavelengths to be transmitted in opposing directions across the optical fiber (e.g., from an optical source of the first optical module to a receiver of the second optical module and vice versa). The channel spacing of the optical sources of each respective optical module is offset or misaligned such that the wavelengths of emitted light do not overlap with each other as they are transmitted or propagated across the optical fiber in opposing directions.

As discussed above, typically, fiber pairs are used for each optical signal propagation direction. Using a bidirectional link or a single optical fiber for both optical signal propagation directions can reduce part and labor costs by 2X (e.g., from fibers and connectors and assembly thereof). Additionally, when using fiber pairs, during fabrication the fiber pairs need to be connected leading to potential human error if they are connected in an incorrect manner or increased system design costs to ensure correct connections. Further, when using fiber pairs, during operation the fiber pairs need to be connected. There may be several optical fiber pairs to be connected in an optical system. Each mated optical connector pair may lead to potential increase in optical signal losses. Therefore, an improved optical system having a bidirectional link with a single optical fiber for both transmitting and receiving multiple wavelengths as described herein may reduce part costs as well as manufacturing or assembly costs, while also improving optical signal performance.

An “optical fiber” as described herein can refer to a single optical fiber (e.g., including a core, a cladding, a buffer and one or more layers of protective jackets) to provide bidirectional optical communication (e.g., both transmit and receive communications in an optical network). A signal or communication path of an optical fiber can extend contiguously and uninterrupted between optical modules. In some examples, the optical fiber includes two or more fibers connected (e.g., sequentially) via fiber-to-fiber connections such that the fibers function or perform as a single communication path. To avoid unnecessarily obscuring the description, conventional or well-known structures and components of optical systems are omitted from the description, for example, optical connectors, tuning circuitry, sensors, and CMOS drivers/receivers to tune, convert, or modulate optical signals or resonators.

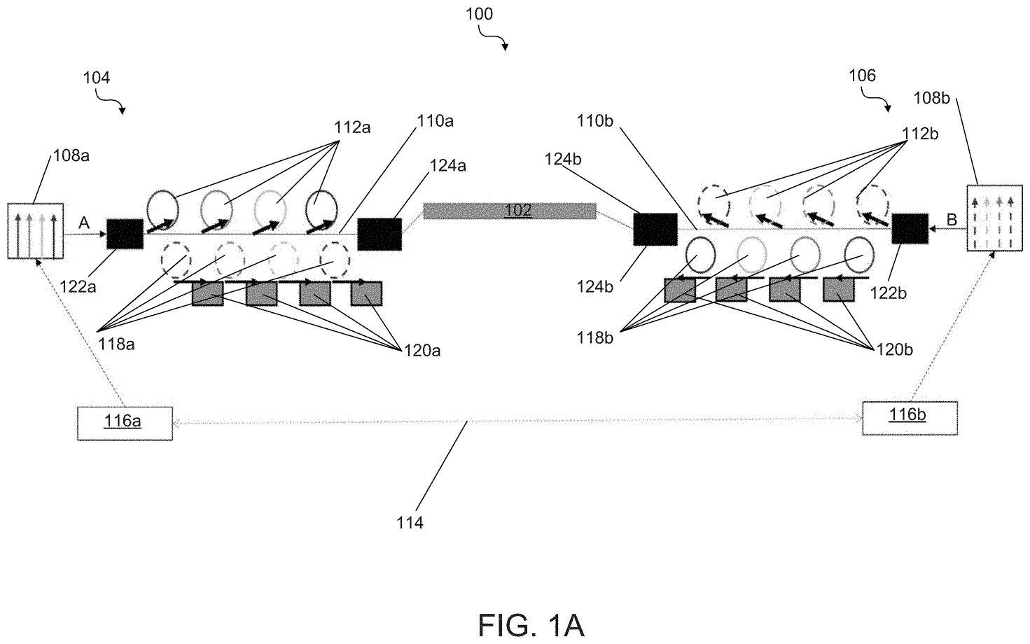

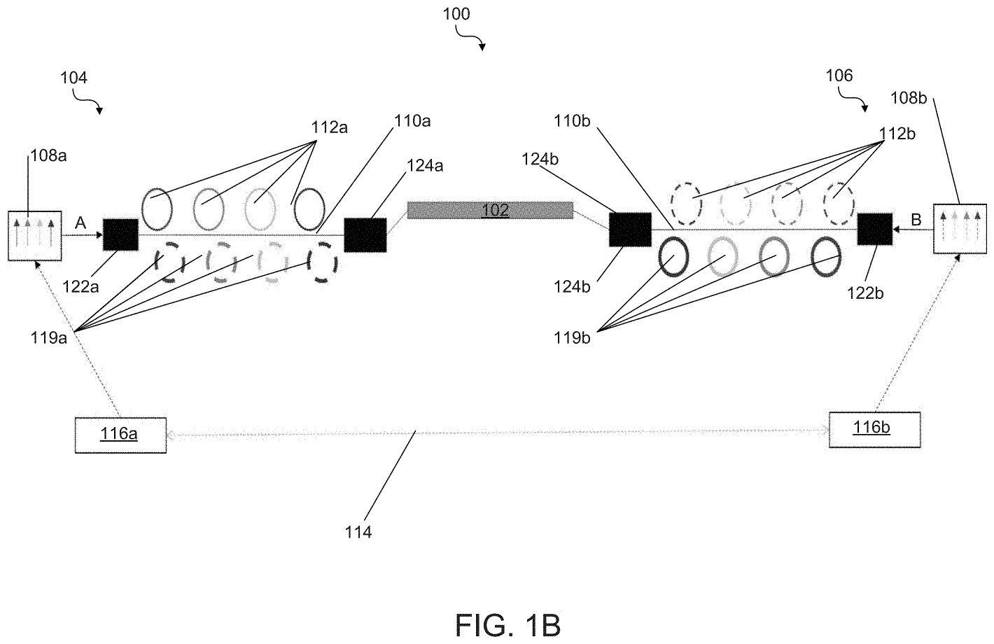

FIGS. 1A-1B illustrate an example of an optical system 100 and components thereof according to the present disclosure. The optical system 100 includes an optical fiber 102 and first and second optical modules 104 and 106 coupled to opposing ends of the optical fiber 102. The optical modules 104 and 106 can be for example, an optical transceiver. The first optical module 104 is configured to transmit optical signals (e.g., wavelengths of light) across the optical fiber 102 in a first direction (identified by arrow A) to be received by the second optical module 106. The second optical module 106 is configured to transmit optical signals across the optical fiber 102 in a second direction (identified by arrow B) opposite the first direction to be received by the first optical module 104. In some implementations, the first optical module 104 can transmit in the first direction independently of the second optical module 106 transmission, and the second optical module 106 can transmit in the second direction independently of the first optical module 104 transmission.

Each of the first and second optical modules 104 and 106 includes at least one optical source 108 (e.g., a multi-wavelength optical source) to emit light (e.g., carrier waves) having different wavelengths or channels to be transmitted in opposite directions across the optical fiber 102. In some examples, the optical modules 104 and 106 can include two or more optical sources 108. Optical sources 108 of respective optical modules 104 and 106 are identified individually herein as optical source 108a and optical source 108b. The optical source 108 can be disposed off-chip (e.g., coupled onto the chip via an optical fiber) or on-chip (e.g., formed on or integrated within the chip) of the respective optical module. For example, the optical source 108 can be a comb laser (e.g., an external comb laser) configured to generate a plurality of different laser or comb lines or wavelengths from a single module and is optically coupled to respective optical modules 104 and 106. In other examples, the optical source 108 can include a plurality of ring lasers disposed on the same chip as optical modules 104 and 106. In yet other examples, the optical source 108 includes an array of directly-modulated ring lasers. As illustrated in FIGS. 1A-1B and described in more detail below, the comb lines of optical source 108a, the transmitting ring resonators 112a, and the receiving ring resonators 118b, that are transmitting or receiving the carrier wavelengths with non-offset channel spacing are shown with solid lines. The comb lines of optical source 108b, the transmitting ring resonators 112b, and the receiving ring resonators 118a, that are transmitting or receiving the carrier wavelengths with offset channel spacing are shown with dashed lines. In other examples, this can be the opposite of what is illustrated.

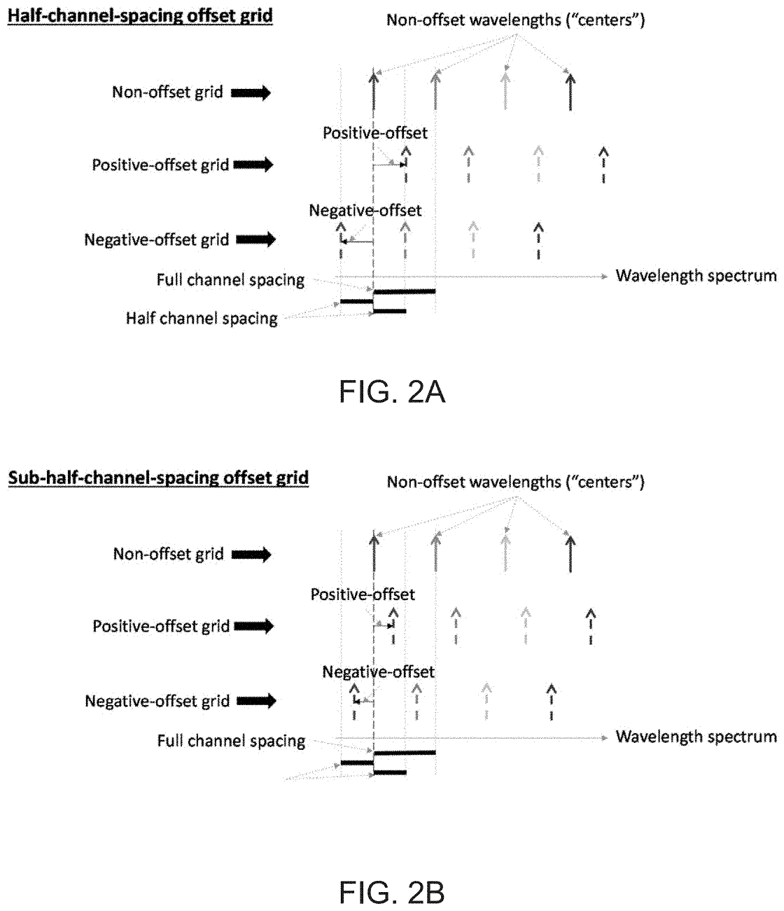

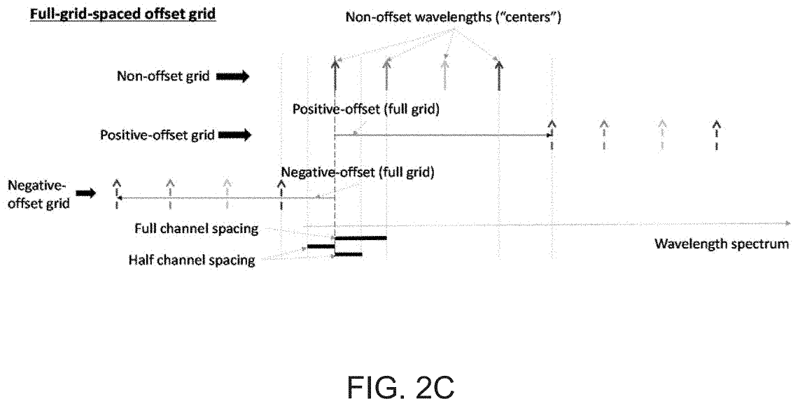

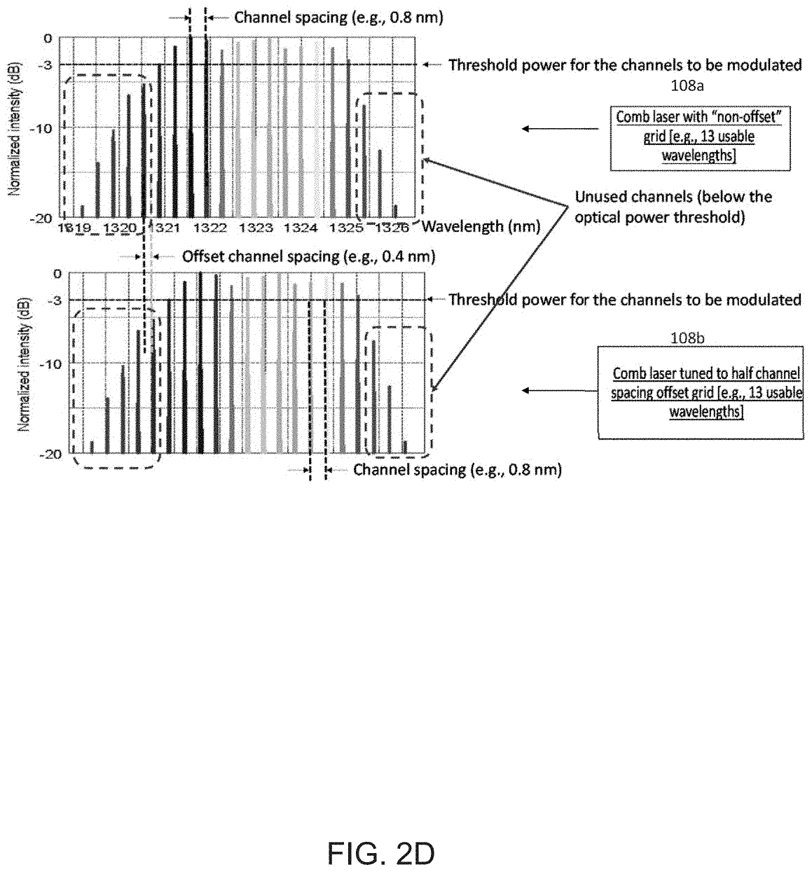

As described in more detail below with respect to FIGS. 2A-2D, respective channel spacing (e.g., the constant distance between each pair of adjacent wavelengths) of the emitted light from the optical sources 108 of the first and second optical modules 104 and 106 are offset from each other such that the respective wavelengths of the emitted light from the optical sources 108 do not overlap (e.g., as they are propagated across the optical fiber 102). The optical system 100 can include a control circuit 114 coupled to the first optical module, second optical module, or both.

For example, the control circuit 114 can include controllers 116a and 116b communicatively and operably coupled to optical sources 108a and 108b with control logic configured (e.g., programmable and executable) to tune at least one of the optical sources 108a and 108b of the first and/or second optical modules 104 and 106 such that the offset channel spacing between the respective wavelengths of the optical sources 108a and 108b is maintained. In some examples, a wavelength grid of the optical source 108b is tuned to be offset from a wavelength grid of the optical source 108a (e.g., the wavelength grid of optical source 108a is maintained or not offset). In other examples, a wavelength grid of the optical source 108a is tuned to be offset from a wavelength grid of the optical source 108b. Thus, light from the respective optical sources 108a and 108b can be propagated across the optical fiber 102 simultaneously in opposite directions. In some examples, the control circuit 114 is a closed-loop circuit. In yet further examples, the control circuit 114 can be further integrated with the ring resonator modulators or tuning circuitry as described in more detail below.

Each of the optical modules 104 and 106 includes a waveguide 110 (identified individually as waveguides 110a and 110b) configured to couple the emitted light from the respective optical sources 108a and 108b to the optical fiber 102. In some examples, the waveguide 110 is a bus waveguide. Each of the optical modules 104 and 106 further includes a first set or array of ring resonators 112 (identified individually as first set of ring resonators 112a and 112b) coupled (e.g., via evanescent coupling) to the respective waveguides 110a and 110b. Each ring resonator of the first set of ring resonators 112 can be tuned to a different resonant wavelength corresponding to a different channel or wavelength of the multiple wavelengths emitted from the respective optical sources 108a and 108b. While illustrated as having four ring resonators, the first set of ring resonators 112 can have a same number of resonators as different or usable wavelengths or channels of the respective optical sources 108an and 108b (e.g., four, eight, sixteen, thirty-two, sixty-four).

The ring resonators are each configured to be tuned to a single wavelength of the emitted light different from the other ring resonators of the first set of ring resonators 112. For example, resonance properties of each ring resonator can be precisely tuned to select the specific wavelength by varying the radius of each ring or by tuning the cladding index. Tuning can be accomplished via thermal tuning (e.g., providing a controllable micro-heater by each ring resonator), bias-tuning, or a combination of both. While referring specifically to ring resonators, in other examples, ring resonators as described herein can be replaced with microdisks or other suitable traveling wave resonators.

When light of the appropriate wavelength is coupled from the waveguide 110 to a corresponding ring resonator of the first set of ring resonators 112, constructive interference causes a buildup in intensity over multiple round-trips through the ring resonator. The ring resonators of the first set of ring resonators 112 can encode electrical signals to the different wavelengths (e.g., modulate via tuning circuitry and a CMOS driver) coupled to each ring resonator. The optical signals from each ring resonator with encoded electrical signals (e.g., modulated optical signals) can be coupled back into the respective waveguides 110a and 110b and recombined (e.g., multiplexed) to be propagated across the optical fiber 102 in opposite directions with respect to each other. Therefore, each of the first set of ring resonators 112a and 112b can be configured as an optical modulator bank or array of optical modulators wherein each ring resonator is acts as an individual modulator.

Each of the optical modules 104 and 106 further includes a receiver module or receiver. The receiver of the first optical module 104 is configured to receive the optical signals transmitted from the second optical module 106 and the receiver of the second optical module 106 is configured to receive the optical signals transmitted from the first optical module 104. Each of the receivers of respective optical modules 104 and 106 can include a second set or array of ring resonators 118 (identified individually as second set of ring resonators 118a and 118b) also coupled (e.g., via evanescent coupling) to respective waveguides 110a and 110b. While illustrated as having four ring resonators, the second set of ring resonators 118 can have a same number of resonators as different or usable wavelengths or channels of respective optical sources 108a and 108b (e.g., four, eight, sixteen, thirty-two, sixty-four).

The ring resonators of the second set of ring resonators 118a and 118b act as filters to drop (e.g., couple in) the respective resonant wavelengths from the respective waveguides 110a and 110b. The second set of ring resonators 118a of optical module 104 receives the multi-wavelength optical signals from optical source 108b modulated by the first set of ring resonators 112b. The optical signals received from optical source 108b propagate in the opposite direction in waveguide 110a as the optical signals emitted by optical source 108a. Conversely, the second set of ring resonators 118b of optical module 106 receives the multi-wavelength optical signals from optical source 108a modulated by the first set of ring resonators 112a. The optical signals received from optical source 108a propagate in the opposite direction in waveguide 110b as the optical signals emitted by optical source 108b. For example, the ring resonators of the respective second set of ring resonators 118a and 118b are configured to demultiplex the light from respective optical sources 108a and 108b propagated across the optical fiber 102 in opposite directions. Resonant wavelengths specific or corresponding to each ring resonator of the second set of ring resonators 118a and 118b are individually demultiplexed into separate photodetectors 120a and 120b (e.g., via “drop” or output waveguides) to convert the optical signals into electrical signals for further processing. The photodetectors can be wide-bandwidth detectors configured to be sensitive to either sets of multi-wavelengths or grids tuned in 104 or 106.

Thus, each of the ring resonators of the respective second set of ring resonators 118a and 118b can “drop” or otherwise filter a single wavelength of modulated light or signals from the multiplexed optical signals having multi-wavelengths of light received across the optical fiber (e.g., from respective first set of ring resonators 112b or 112a. Similar to the first set of ring resonators 112, the second set of ring resonators 118 can be tuned as well. While illustrated as separate components, in other examples, the ring resonators of the second set of resonators 118 and the photodetectors 120 can be integrated together. For example, a set of micro-rings 119 (identified as micro-rings 119a and 119b) configured as wavelength-selective photodetectors can be used (FIG. 1B).

Each of the optical modules 104 and 106 can further include first and second optical couplers 122 and 124 (identified individually as first optical couplers 122a and 122b and second optical couplers 124a and 124b). The first optical couplers 122a and 122b are configured to couple the emitted light from respective optical sources 108a and 108b to the waveguides 110a and 110b, respectively. The second optical couplers 124a and 124b are configured to couple the emitted light from the respective waveguides 110a and 110b to the optical fiber 102 after the emitted light has passed through the respective first set of ring resonators 112a and 112b of respective optical modules 104 and 106. The optical couplers as described herein can include, but are not limited to: grating couplers, prisms, collimating lenses, light-turn lenses, parabolic reflectors, spot-size converters, inversely tapered waveguides, bent waveguides, or a combination thereof. In some examples, the optical couplers 122 and 124 may be fixed attached correspondingly to the optical modules 104 and 106. In other examples, the optical couplers 122 and 124 may be modularly attached correspondingly to the optical modules 104 and 106 by using optical connector housings. Further, in some examples, each of the optical modules 104 and 106 can include filter or filter blocks configured to filter out or remove unusable wavelengths of light (e.g., wavelengths with insufficient optical power as illustrated in FIG. 2D) emitted from optical sources 108a and 108b. For example, such filters can be positioned or otherwise disposed between the optical couplers and the waveguides (e.g., before or after any of the optical couplers 122 and 124). In some examples, the filters or filter blocks are disposed in a position before wavelengths of light emitted from respective optical sources reach the first set of ring resonators 112.

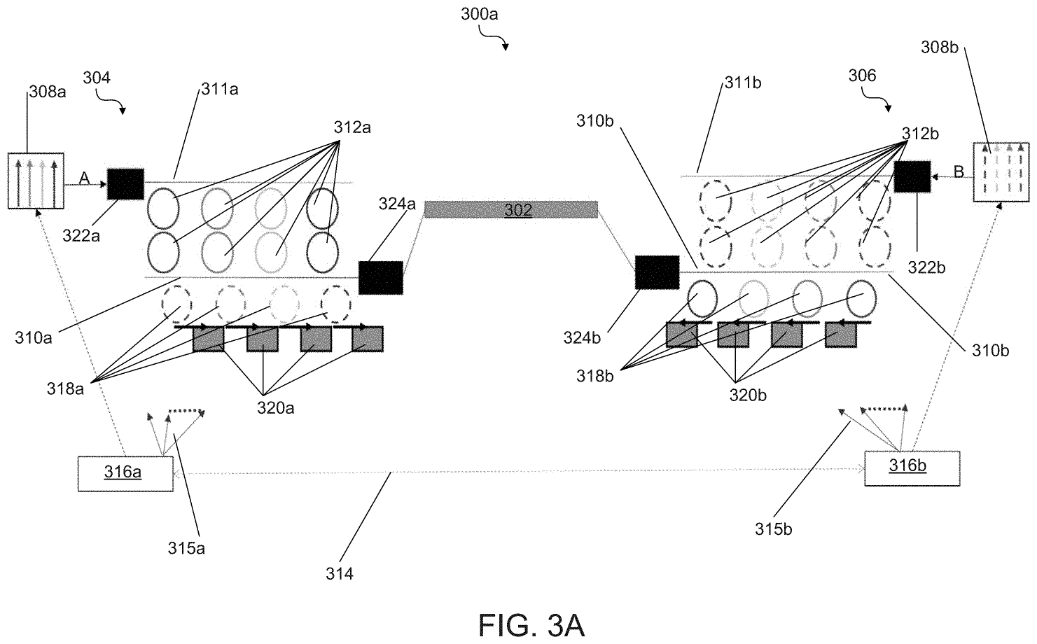

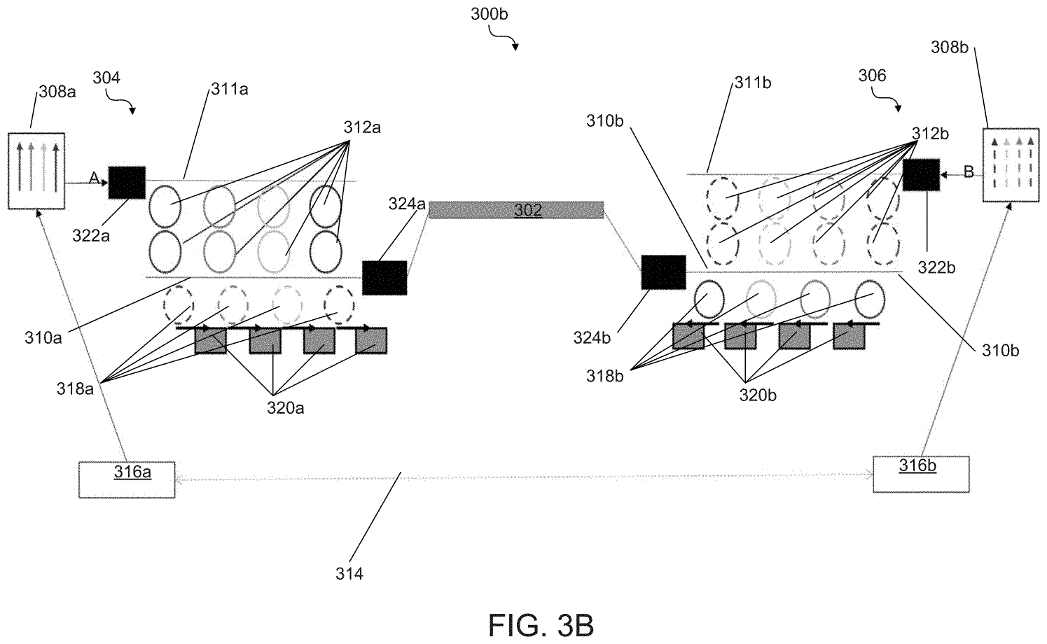

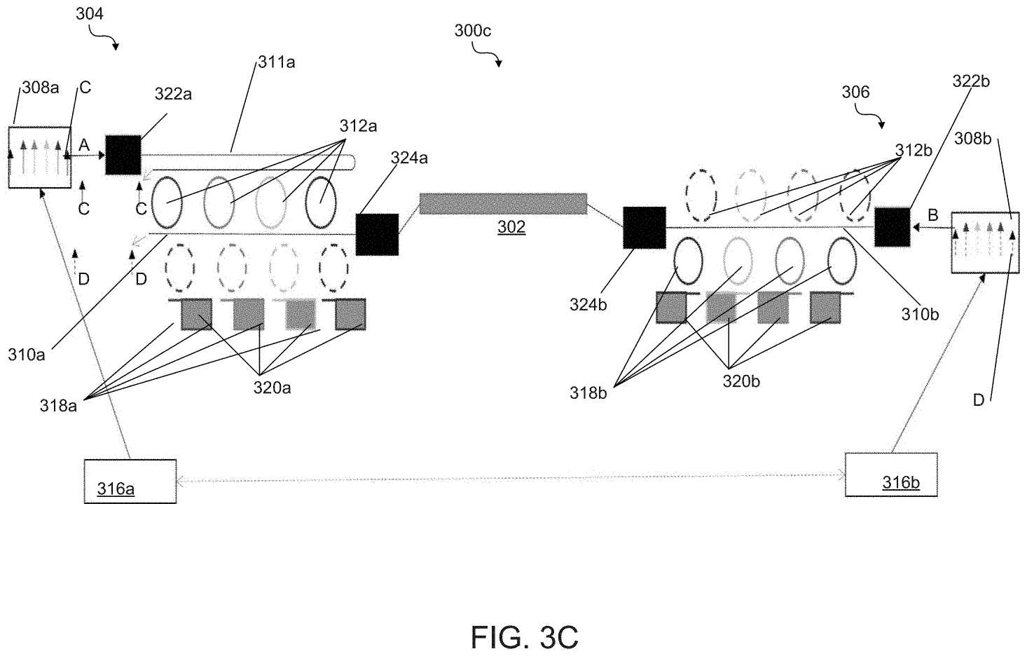

As described above, the optical system 100 allows or is configured to allow simultaneous transmission of a first set of wavelengths and a second set of wavelengths in opposing directions across the optical fiber 102. With reference to FIGS. 2A-2D illustrating the wavelength spectrum of the optical sources 108, the respective channel spacing of the optical sources 108 of the first and second optical modules 104 and 106 are offset or spaced apart relative to each other while the optical sources 108 have the same or identical channel spacing. The channel spacing can be a positive offset (e.g., longer wavelength relative to corresponding non-offset wavelength) or negative offset (e.g., shorter wavelength relative to corresponding non-offset wavelength) about respective center wavelengths of the non-offset wavelength set or grid. The channel spacing can be equal or symmetric (e.g., half channel spacing) or unequal or asymmetric (e.g., sub-half-channel spacing). In some examples, the first set of ring resonators 112a of the first optical module 104 is configured to be locked (e.g., via ring tuning logic or circuitry as illustrated in FIG. 3A) to a same wavelength grid of the optical source 108a as the second set of ring resonators 118b of the second optical module 106. Conversely, the first set of ring resonators 112b of the second optical module 106 is configured to be locked to a same wavelength grid of the optical source 108b (e.g., via ring tuning logic) as the second set of ring resonators 118a of the first optical module 104.

In some examples (FIGS. 2A and 2D), the channel spacing or offset is a half channel spacing (e.g., to reduce or minimize cross-talk). The respective channel spacing of the emitted light from the optical sources 108 of the first and second optical modules can be in a range from about or equal to 50 GHz to about or equal to 200 GHz. For example, if the channel spacing of the optical sources 108 is 80 GHz, the offset or spacing between relative channels of the respective optical sources is 40 GHz (e.g., forward and backward) if the offset is a half channel such that the wavelengths of light from respective optical sources do not overlap with each other. In another example, if the channel spacing of the optical sources 108 is 120 GHz, the offset or spacing between relative channels of the respective optical sources is 60 GHz (e.g., forward and backward) if the offset or spacing is a half channel spacing such that the wavelengths of light from respective optical sources do not overlap with each other. As illustrated in FIG. 2D, with respect to wavelength, if the channel spacing is 0.8 nm, the offset half-channel is 0.4 nm between respective optical sources 108. Further, as discussed above, some wavelengths or channels may be unused or unusable if they are under an optical power threshold (e.g., to be modulated). In some examples, these unused channels can be filtered out accordingly. In other examples, these comb lines or channel are unmodulated.

In other examples (FIG. 2B), the channel spacing or offset is sub-half channel or asymmetric. The offset channel spacing is less than a half channel spacing (e.g., ⅕, ¼, ⅓, ⅖, or any value there between). In certain examples, when the optical sources 108a and 108b are tuned such that offset channel spacing is less than a half channel, the optical systems can be configured without tuners for the corresponding sets of ring resonators (e.g., the first set of ring resonators 112a of the optical module 104 and second set of ring resonators 118b of the second optical module 106) to lock such ring resonators to the off-set or non-offset wavelength grids of the respective optical sources they are coupled to or configured to receive. For example, with sub-half-channel spacing, the wavelengths of the offset optical source are sufficiently close to centers of respective wavelengths of the non-offset optical source such that only the optical sources may need to be tuned. With half-channel spacing, ring resonator tuning circuitry can ensure that the corresponding sets of ring resonators are locked to respective off-set or non-off-set grids of the optical sources they modulate or receive optical signals from.

In yet other examples (FIG. 2C), the offset channel spacing can be much greater than a half-channel. As illustrated, the channel spacing or offset can be a full-grid or greater. In such examples, the offset is such that the first channel of a first optical source (e.g., optical source 108a) is spaced from a last channel of the second optical source (e.g., optical source 108b) such that the channels do not overlap. Further, the first channel of the first optical source has a longer wavelength than the last channel of the second optical source.

FIGS. 3A-3C illustrate other examples of optical systems 300 (identified individually as 300a-300c) according to the present disclosure. The optical systems 300 can include one or more features, in whole or in part, identical or otherwise similar to those described with respect to optical system 100. Identical reference numbers identify identical, or at least generally similar, elements. For example, the optical systems 300 an optical fiber 302 and first and second optical modules 304 and 306. The first and second optical modules 304 and 306 include optical sources 308, first and second sets of ring resonators 312 and 318, and first waveguides 310. The first waveguides 310 are identified individually as waveguides 310a and 310b.

As illustrated, the optical systems 300 also include respective second waveguides 311a and 311b configured to couple light from the respective optical sources 108a and 108b to the first set of ring resonators 312a and 312b. As illustrated in FIGS. 3A-3B, each of resonators of the first set of ring resonators 312 can include two or more cascaded ring resonators to further couple the different wavelengths of light to the first waveguides 310a and 310b with proper orientation or direction. In other examples (FIG. 3C), the second waveguide 311 can include a bend or turn to couple the light with first waveguide 310 with proper light orientation or direction without the cascaded resonators.

The wavelengths of light can then be transmitted across the optical fiber via the first waveguides 310a and 310b in opposite directions as described above with respect to optical system 100 to be received by respective second sets of ring resonators 318. By including second waveguides 311, unused or unusable wavelengths (e.g., wavelengths with insufficient power to be modulated) of the respective optical sources 308a and 308b can be filtered out (e.g., see wavelengths identified by short arrows C from optical source 308a) such that they are not transferred to the first waveguides 310a and 310b for transmission across the optical fiber 302. Further, as illustrated in FIG. 3C, if one optical module includes the second waveguide 311 (e.g., second waveguide 311a of optical module 304) and one does not (e.g., optical module 306), the unusable wavelengths from optical source 308b (identified by short arrows D) can still be filtered out of waveguide 310a at optical module 304. This reduces or prevents likelihood of these unused or unusable wavelengths emitted from one of optical sources 308a and 308b from disturbing wavelengths transmitted from the other of the optical sources 308a and 308b or received at each module. Additionally, this can provide a more simple optical source design (e.g., not requiring optical isolators). One or both of optical modules 304 and 306 can include first and second waveguides 310 and 311.

As described above with respect to optical system 100, optical system 300a can further include control logic 315 to tune the individual rings of the sets of ring resonators 312 and 318 such that they are locked to respective off-set or non-offset wavelength grids of respective optical sources 308a or 308b. The optical system 300a can include half channel spacing between the respective optical sources 308a or 308b. In yet other examples (FIG. 3B), the optical system 300b can be configured without such ring tuning mechanisms or logic/circuitry 315. In optical system 300b, the channel spacing can be sufficiently close (e.g., less than half-channel spacing) such that such tuning mechanisms are not necessary to lock the sets of ring resonators to respective off-set or non-offset grids of respective optical sources as described above with respect to FIG. 2B.

Further, as described herein, optical systems (e.g., optical systems 100 and 300) can include multiple optical modules and optical fibers. For example, optical system 100 can include two optical modules 104 and two optical modules 106 configured to be coupled via two bi-directional optical fibers 102 as described herein. Thus, the optical system includes a fiber array including the two optical fibers formed between the respective optical modules.

In the foregoing description, numerous details are set forth to provide an understanding of the subject disclosed herein. However, implementations can be practiced without some or all of these details. Other implementations can include additions, modifications, or variations from the details discussed above. It is intended that the appended claims cover such modifications and variations. The specification and drawings are, accordingly, to be regarded as illustrative rather than restrictive.

It will be recognized that the terms “comprising,” “including,” and “having,” as used herein, are specifically intended to be read as open-ended terms of art. The term “or,” in reference to a list of two or more items, covers all of the following interpretations of the word: any of the items in the list, all of the items in the list, and any combination of the items in the list. As used herein, the terms “connected,” “coupled,” or any variant thereof means any connection or coupling, either direct or indirect (e.g., having additional intervening components or elements), between two or more elements, nodes, or components; the coupling or connection between the elements can be physical, mechanical, logical, optical, electrical, or a combination thereof.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

1. An optical system comprising:
an optical fiber;
first and second optical modules coupled to opposing ends of the optical fiber, wherein the first optical module is configured to transmit optical signals across the optical fiber in a first direction and the second optical module is configured to transmit optical signals across the optical fiber in a second direction opposite the first direction, and wherein each of the first and second optical modules comprises:
an optical source configured to emit light having different wavelengths;
a waveguide configured to couple the emitted light from the optical source to the optical fiber;
a first set of ring resonators coupled to the waveguide, each ring resonator of the first set of ring resonators corresponding to a different wavelength of the emitted light from the optical source, and wherein each ring resonator is configured to be tuned to a single wavelength of the emitted light different from the other ring resonators of the first set of ring resonators;
first and second optical couplers, the first optical coupler configured to couple the emitted light from optical source to the waveguide and the second optical coupler configured to couple the emitted light from the waveguide to the optical fiber after the emitted light has passed through the first set of ring resonators; and
wherein respective channel spacing of the emitted light from the optical sources of the first and second optical modules are offset from each other such that the respective wavelengths of the emitted light from the optical sources do not overlap.

2. The optical system of claim 1, wherein the optical source comprises an on- or off-chip multi-wavelength comb laser.

3. The optical system of claim 1, wherein the respective channel spacing of the emitted light from the optical sources of the first and second optical modules are offset by a positive or negative half channel spacing from each other.

4. The optical system of claim 1, wherein the respective channel spacing of the emitted light from the optical sources of the first and second optical modules is in a range from 50 GHz to 200 GHz.

5. The optical system of claim 1, wherein the respective channel spacing of the emitted light from the optical sources of the first and second optical modules is identical.

6. The optical system of claim 1, wherein each of the first and second optical modules further comprises a receiver, the receiver comprising a plurality of photodetectors and a second set of ring resonators coupled to the waveguide of the respective first and second optical modules, each ring resonator of the second set of ring resonators corresponding to and configured to receive a different wavelength of the emitted light from the optical source, wherein the second set of ring resonators of the first optical module is configured to receive emitted light from the second optical module and the second set of ring resonators of the second optical module is configured to receive emitted light from the first optical module, and wherein each ring resonator is configured to be tuned to a single wavelength of the emitted light different from the other ring resonators of the second set of ring resonators.

7. The optical system of claim 1, wherein the first set of the ring resonators of each of the first and second optical modules are modulators forming a portion of an optical modulator bank to encode electrical signals to the different wavelengths of the emitted light prior to transmission over the optical fiber.

8. The optical system of claim 1, wherein the plurality of ring resonators are tuned via at least bias tuning, thermal tuning, or both.

9. The optical system of claim 1, wherein the optical signals from the respective first and second optical modules are transmitted simultaneously across the optical fiber.

10. The optical system of claim 1, further comprising a control circuit coupled to at least one of the first or second optical modules, the control circuit having a controller to tune at least one of the first or second optical sources such that the channel spacing of the emitted light from the optical sources of the first and second optical modules are offset from each other.

11. The optical system of claim 1, wherein at least one of the optical sources of the first or second optical modules is coupled to the control circuit in a closed-loop manner.

12. An optical system comprising:
an optical fiber;
first and second optical modules coupled to opposing ends of the optical fiber, wherein the first optical module is configured to transmit optical signals across the optical fiber in a first direction and the second optical module is configured to transmit optical signals across the optical fiber in a second direction opposite the first direction, and wherein each of the first and second optical modules comprises:
a multi-wavelength optical source configured to emit light; and
wherein respective channel spacing of the multi-wavelength optical sources of the first and second optical modules are offset from each other such that the respective wavelengths of the emitted light transmitted across the optical fiber from the optical sources do not overlap.

13. The optical system of claim 12, wherein the multi-wavelength optical source comprises an on- or off-chip multi-wavelength comb laser.

14. The optical system of claim 12, wherein the multi-wavelength optical source comprises a set of ring lasers or a directly-modulated ring laser array.

15. The optical system of claim 12, wherein the respective channel spacing of the emitted light from the multi-wavelength optical sources of the first and second optical modules are offset by a positive or negative half channel spacing from each other.

16. The optical system of claim 12, wherein the respective channel spacing of the emitted light from the multi-wavelength optical sources of the first and second optical modules is in a range from 50 GHz to 200 GHz.

17. The optical system of claim 12, wherein the respective channel spacing of the emitted light from the multi-wavelength optical sources of the first and second optical modules is identical.

18. The optical system of claim 12, wherein the optical signals from the respective first and second optical modules are transmitted simultaneously across the optical fiber.

19. The optical system of claim 12, further comprising a control circuit coupled to at least one of the first or second optical modules, the control circuit having a controller to tune at least one of the first or second multi-wavelength optical sources such that the channel spacing of the emitted light from the multi-wavelength optical sources of the first and second optical modules are offset from each other.

20. The optical system of claim 12, wherein at least one of the multi-wavelength optical sources of the first or second optical modules is coupled to the control circuit in a closed-loop manner.
